(19) United States
(12) Patent Application Publication
(10) Pub. No.: US 2010/0126058 A1
(43) Pub. Date: May 27, 2010

(54) FISHING LURE THAT SIMULATES A DYING FISH

(75) Inventor: Timothy Richard HUGHES, Reeds Spring, MO (US)

Correspondence Address: PILLSBURY WINTHROP SHAW PITTMAN, LLP, P.O. BOX 10500, MCLEAN, VA, 22102, US

(73) Assignee: Bass Pro Intellectual Property, L.L.C., Springfield, MO (US)

(21) Appl. No.: 12/275,691

(22) Filed: Nov. 21, 2008

(51) Int. Cl. A01K 85/00; A01K 85/16

(52) U.S. Cl. 43/42.39; 43/42.03; 43/42.47; 43/42.48

(57) ABSTRACT

A fishing lure includes a lure body, a weight and fins. The lure body is shaped like a fish, and includes a top side and a bottom side. The lure body is weighted such that it is biased towards a top side down orientation if the lure is suspended in water without being pulled through water. The at least one angled surface on the body tend to propel the lure body towards a top side up orientation if the lure is pulled through water.

### BACKGROUND OF THE INVENTION

### Field of the Invention

The present invention relates to a fishing lure that simulates a dying fish.

Fishing lures are well known for use in catching fish. Fishing lures are attached to an end of a fishing line and designed to attract a fish to bite on a hook attached to the fishing lure. Fishing lures are designed to simulate or resemble a natural food source (e.g., a bait fish) for the fish both in appearance and in movement. The present invention provides improvements over the prior art fishing lures.

### SUMMARY OF THE INVENTION

One aspect of the present invention is a fishing lure. The fishing lure includes a lure body, a weight and fins. The lure body is shaped like a fish, and includes a top side and a bottom side. The lure body is weighted such that it is biased towards a top side down orientation if the lure is suspended in water without being pulled through water. The at least one angled surface on the body that tend to propel the lure body towards a top side up orientation if the lure is pulled through water.

Another aspect of the present invention is a fishing lure. The fishing lure includes a lure body, and a front lip. The lure body is shaped like a fish, and includes a top side and a bottom side. The front lip extends downwardly and forwardly relative to a front end of the lure body, and causes the lure body to wiggle if the lure is pulled through water. The front lip is rotatable relative to the lure body, the lip is weighted such that it retains the downwardly and forwardly extending orientation relative to the front end of the lure body irrespective of whether the lure body is in a top side up or top side down orientation.

Another aspect of the present invention is a fishing lure. The fishing lure includes a lure body, and a rear hook. The lure body is shaped like a fish, and includes a top side and a bottom side. The rear hook is weighted such that it rotates relative to the lure body so that pointed end of the hook always extends in a generally vertically upward direction irrespective of whether the lure body is in a top side up or top side down orientation.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. In one embodiment, the drawings can be understood as drawn to scale, although that is not required. As used in the specification and in the claims, the singular form of “a”, “an”, and “the” include plural referents unless the context clearly dictates otherwise.

### BRIEF DESCRIPTION OF THE DRAWINGS

FIG. 1 is a perspective view of a fishing lure in a top side down orientation, when the lure is suspended in water without being pulled through water in accordance with an embodiment of the present invention;

FIG. 2 is a perspective view of the fishing lure in a top side up orientation in accordance with an embodiment of the present invention;

FIG. 3 is a perspective view of the fishing lure in the top side up orientation, wherein fins tend to propel the lure body towards the top side up orientation if the lure is pulled through water in accordance with an embodiment of the present invention;

FIG. 4 is a cross-sectional view taken through the line 4-4 axis of FIG. 1;

FIG. 5 is a front view of a rotatable front lip of the fishing lure in accordance with an embodiment of the present invention;

FIG. 6 is a perspective view of a fishing lure in a top side down orientation, when the lure is suspended in water without being pulled through water in accordance with another embodiment of the present invention; and

FIG. 7 is a cross-sectional view taken through the line 7-7 axis of FIG. 6.

### DETAILED DESCRIPTION OF THE INVENTION

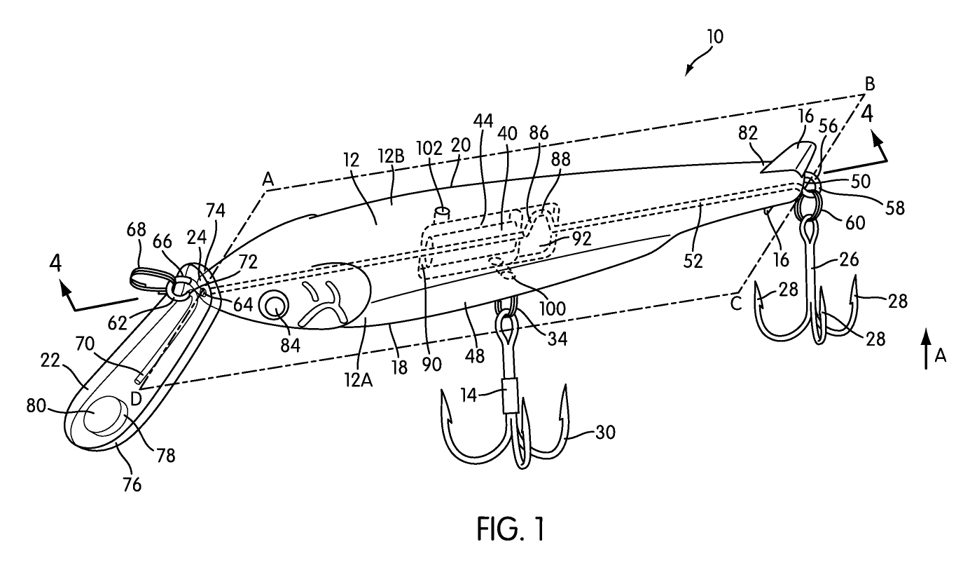

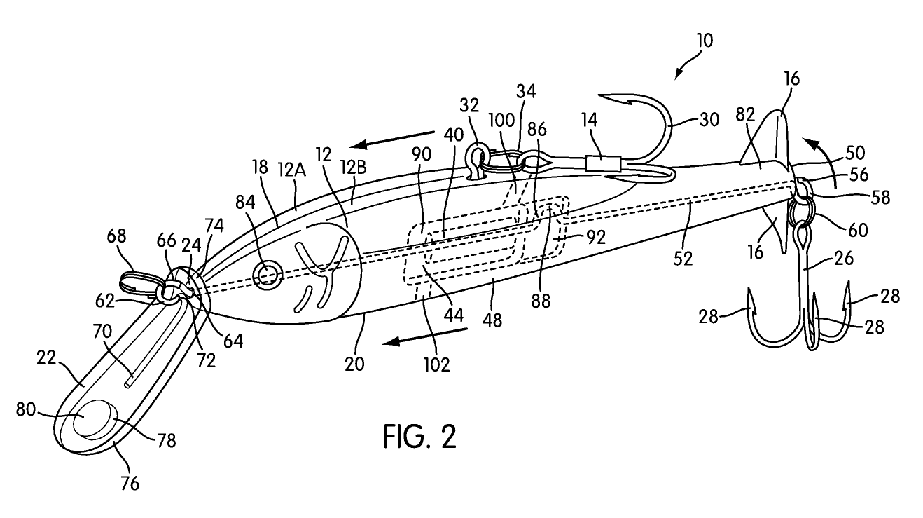

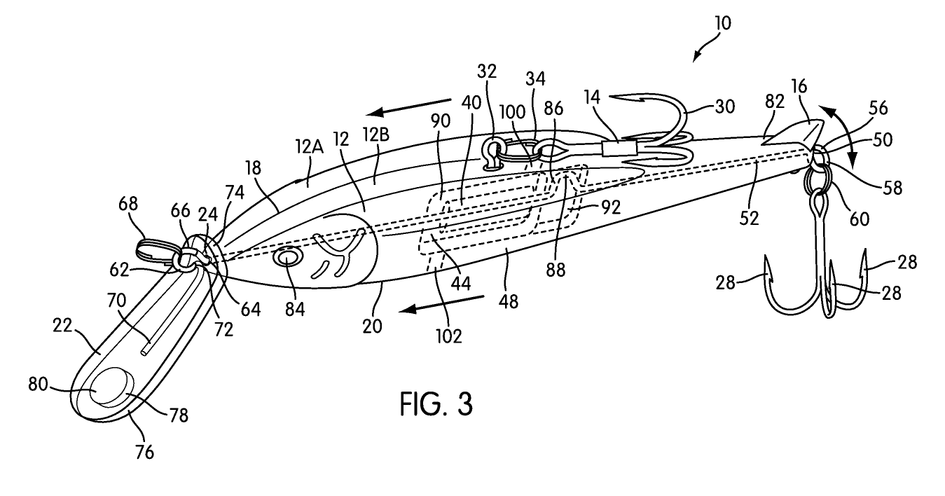

FIG. 1 shows a fishing lure 10 in a top side down orientation in accordance with an embodiment of the invention. The fishing lure 10 may generally include a lure body 12, a weight 14 and at least one angled surface 16 on the body. The lure body 12 is shaped like a fish, and includes a top side 18 and a bottom side 20. The weight 14 is positioned to bias the lure body 12 towards the top side down orientation if the lure 10 is suspended in water without being pulled through water. The at least one angled surface 16 on the body that tend to propel the lure body 12 towards a top side up orientation (as shown in FIGS. 2 and 3) if the lure 10 is pulled through water.

In one embodiment, the at least one angled surface on the body is provided by one or more fins. The fins 16 are, in this embodiment, disposed towards the rear of the lure body 12. The fins 16 can be located in other regions, such as towards the middle of the lure body 12. The fins 16 can optionally appear as an anatomically correct part of a fish's body, or optionally not (as in the illustrated embodiment).

In one embodiment, the fishing lure 10 may include a front lip 22. In one embodiment, the front lip 22 may be rotatable relative to the lure body 12. The front lip 22 causes the lure body 12 to wiggle if the lure 10 is pulled through water. The front lip 22 is weighted such that it retains a generally downwardly and forwardly extending orientation relative to a front end 24 of the lure body 12 irrespective of whether the lure body 12 is in the top side up or top side down orientation.

In one embodiment, the fishing lure 10 may include a rear hook 26 that is rotatable relative to the lure body 12 (or the lure body 12 can be considered to be rotatable relative to the rear hook 26 and relative to the front lip 22). The rear hook 26 can be weighted such that it rotates relative to the lure body 12 so that pointed end(s) 28 of the hook 26 always extends in a generally vertically upward direction (e.g., as shown by an arrow A in FIG. 1) irrespective of whether the lure body 12 is in the top side up or top side down orientation.

In one embodiment, the lure body 12 of the fishing lure 10 is made from wood. Alternatively, in another embodiment, the lure body 12 of the fishing lure 10 is made from a plastic material. In one embodiment, the lure body 12 may include opposing, body portions 12A and 12B, where 12A represents the left body portion and 12B represents the right body portion (See FIGS. 2 and 3).

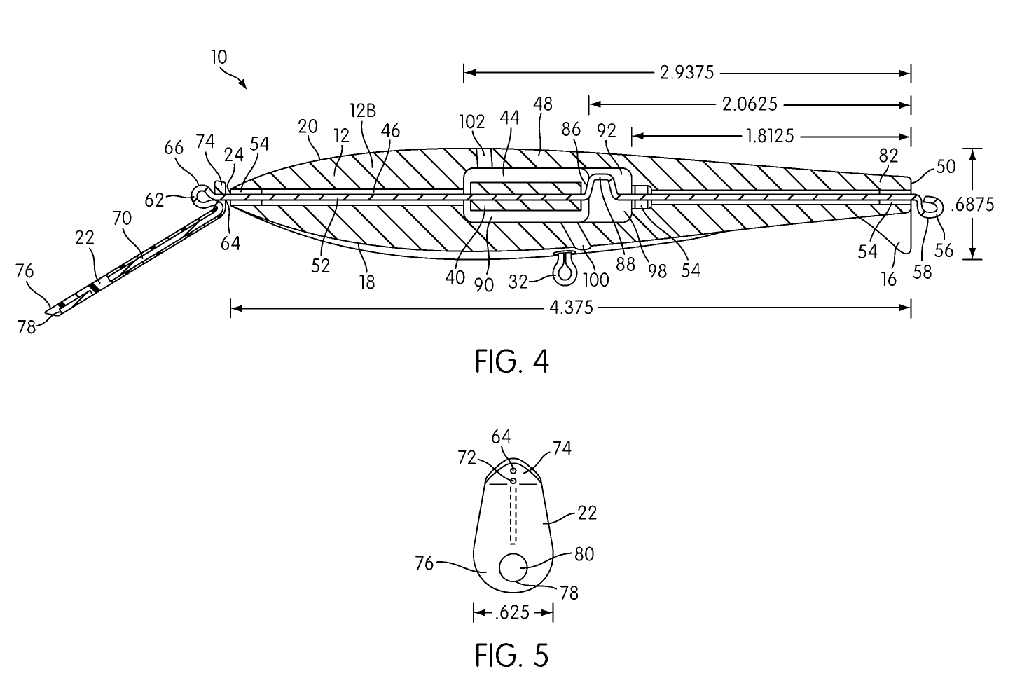

In one embodiment, the opposing, body portions 12A and 12B are joined to each other to define a chamber 44 and a slot 46 (as shown in FIG. 4) therebetween. In one embodiment, the chamber 44 is positioned in a central portion 48 of the lure body 12. In one embodiment, the chamber 44 includes a first portion 90 and a second portion 92.

The first portion 90 of the chamber 44 is constructed and arranged to receive a weight 40 therein. The weight 40 is connected to the lip 22 and the rear hook 26 using a wire or rod 52 as will be described in detail in the discussions below. The weight 40 is rotatable together with the lip 22 and the rear hook 26 (they are all rotatable relative to the lure body 12 or the lure body 12 can be considered to be the rotatable portion, as there is no difference from a relative rotation standpoint as would be appreciated by one of skill in the art). The weight 40 is positioned within the lure body 12 to balance the fore/aft weight of the fishing lure 10 so that the lure body 12 is generally disposed towards a level orientation (balanced) when in water. As described below, the weight 40 provides a counterbalance to a weight 80 carried by the lip 22 that retains the lip 22 in a downwardly and forwardly extending configuration.

In one embodiment, the weight 40 is cylindrical in shape with a central opening therethrough for attaching with the weight 40. However, it is contemplated that different shapes, configurations, and/or constructions of the weight 40 can be provided. In one embodiment, the weight 40 is attached to the wire 52 along a surface portion of the weight 40. In one embodiment, the weight 40 is attached to the wire 52 near a central portion 86 of the wire 52. The weight 40 attached to the wire 52 is constructed and arranged to rotate about its axis, relative to the lure body 12 (or vice versa). In one embodiment, the wire 52 is constructed and arranged to rotate 180 degrees about its axis, relative to the longitudinal axis of the lure body 12. This limited motion prevents continuous rotation of the lure body 12 relative to the lip 22. Rather rotation between the topside up and topside down orientations takes place along an arc of 180 degrees. In one embodiment, the arc is as small as 150 degrees. In another embodiment, the arc is as large as 210 degrees. The fins or propeller 16 is arranged to bias the rotational movement of the lure body 12 in a direction opposite to the direction in which the weight 14 tends to rotate the lure body 12.

The weight 14 need not be provided on the hook 30, but can be anywhere located. The weight 14 can indeed be integrated into the lure body 12 by changing the density of the lure body 12 or adding an embedded weight to give it the asymmetric and/or top-heavy weight that causes it to rotate to the topside down configuration.

The second portion 92 of the chamber 44 is constructed and arranged to receive a bent portion 88 of the wire 52 therein. The bent portion 88 of the wire is located near the central portion 86 of the wire 52. The bent portion 88 of the wire 52 is constructed and arranged to be engaged with an inner surface 98 (as shown in FIG. 4) of the second portion 92 of the chamber 44 to limit the rotational movement of the wire 52 and, thus, to limit the rotational movement of the lip 22 and the rear hook 26. In one embodiment, the rotational movement of the wire 52 is limited to 180 degrees. In one embodiment, the bent portion 88 of the wire 52 has a trapezoidal shape. However, it is contemplated that different shapes, configurations, and/or constructions of the bent portion 88 can be provided. In one embodiment, the first portion 90 of the chamber 44 is constructed and arranged to be deeper than the second portion 92 of the chamber 44 to accommodate the weight 40 therewithin. For example, the chamber portion 92 may occupy portions of both lure halves 12A and 12B. On the other hand, the chamber portion 92 may only reside only in the one half 12A (or 12B), with the inner surface 98 being part of the interior of the opposite half 12B (or 12A).

In one embodiment, as shown in FIG. 4, the slot 46 runs from the front end 24 to a rear end 50 of the lure body 12. The slot 46 is constructed and arranged to receive the wire 52 therein. As shown in FIGS. 1-3, the left body portion 12A and the right body portion 12B encloses the wire 52 therebetween as the left body portion 12A and the right body portion 12B are adhered to one another.

In one embodiment, the wire 52 is made from titanium material. In another embodiment, the wire 52 is made from a memory alloy material. As shown in FIGS. 2-4, a rear end portion 56 of the wire 52 is shaped to form a loop 58 that is constructed and arranged to receive a ring 60. The rear loop 58 may be connected to the rear hook 26 using the ring 60.

A front end portion 62 of the wire 52 is constructed and arranged to pass through an opening 64 on the front lip 22. After passing through the opening 64 on the front lip 22, the front end portion 62 of the wire 52 is shaped to form a fishing line loop 66. The fishing line loop 66 is constructed and arranged to facilitate attachment of the fishing lure 10 to a fishing line (not shown). The fishing lure 10 may be connected to the fishing line at the loop 66 by any attachment mechanism, such as tying the fishing line to the loop 66. In one embodiment, the fishing line is secured directly to the fishing line loop 66. In another embodiment, the fishing line is connected to the fishing line loop 66 by using a connector, such as a ring 68.

The front end portion 62 of the wire 52 also includes an attachment portion 70 that extends beyond the fishing line loop 66, where the attachment portion 70 is constructed and arranged to be embedded into the front lip 22 to attach the front lip 22 to the wire 52. In one embodiment, the attachment portion 70 is constructed and arranged to pass through an opening 72 in the front lip 22 before being embedded into the front lip 22.

In one embodiment, as shown in FIG. 4, the fishing lure 10 may include bearings 54 (three are shown in the illustrated embodiment) that are constructed and arranged to rotatably support the wire 52 in place within the slot 46 of the lure body 12. In one embodiment, the bearings 54 are located near the front end 24, the rear end 50, and in the central portion 48 of the lure body 12. In one embodiment, the slot 46 of the lure body 12 (e.g., near the front end 24, near the rear end 50, and in the central portion 48 of the lure body 12) may include grooves that are constructed and arranged to receive the connector portions 54 therewithin.

The front lip 22 is shown in FIG. 5. In one embodiment, the front lip 22 is made from a plastic material. In one embodiment, the front lip 22 includes chamfered edges. In one embodiment, the width of the front lip 22 is 0.625 inches. In one embodiment, the front lip 22 includes a first portion 74 and a second portion 76. In one embodiment, as shown in FIGS. 1-4, the first portion 74 of the front lip 22 is directed in a generally vertical upwardly direction. In one embodiment, as shown in FIGS. 1-4, the second portion 76 of the front lip 22 is positioned at an angle with respect to the first portion 74 of the front lip 22. In other words, the second portion 76 of the front lip 22 extends downwardly and forwardly relative to the front end 24 of the lure body 12, as shown in FIG. 1-4.

As noted above, the front lip 22 includes two openings 64 and 72 that are constructed and arranged to allow the front end portion 62 of the wire 52 to pass therethrough and to attach the front lip 22 to the wire 52. In one embodiment, as shown in FIG. 5, the two opening 64 and 72 are positioned in the first portion 74 of the front lip 22. As noted above, the attachment portion 70 of the wire 52 is embedded into the second portion 76 of the front lip 22 to attach the front lip 22 to the wire 52. In one embodiment, the second portion 76 of the front lip 22 may include a slot to receive the attachment portion 70 of the wire 52 therethrough.

In one embodiment, the front lip 22 includes a notch or groove 78 constructed and arranged to receive a weight 80 therein. In one embodiment, the weight 80 in the groove 78 of the front lip 22 is constructed and arranged to provide the weighted configuration for the lip 22 to retain the lip 22 in the downwardly and forwardly extending orientation of the lip 22. In one embodiment, this weight 80 is counterbalanced by weight 40 so as to provide horizontal balance to the fishing lure 10. In one embodiment, the weight 80 in the groove 78 of the front lip 22 is made from a lead material. In one embodiment, the weight 80 in the groove 78 of the front lip 22 is approximately 0.5 grams.

In the illustrated embodiment, as shown in FIGS. 1-3, the rear hook 26 is a three pronged hook or a treble hook. In another embodiment, the rear hook 26 may include a single hook or a double hook. In one embodiment, the loop 58 may be connected to the hook 26 using the ring 60.

As shown in FIGS. 1-3, the fins 16 are located in a rear portion 82 of the lure body 12. In one embodiment, the fins 16 are made from a plastic material. In one embodiment, the fins 16 are molded as a part of the lure body 12. In another embodiment, the fins 16 can be attached to the lure body 12 by being slid into grooves (not shown) formed in the lure body 12 and adhering them in place (e.g., via an adhesive).

In one embodiment, as shown in FIGS. 1-3, the hook 30 is attached to the top side 18 of the right body portion 12B of the lure body 12. In other words, the loop 32 is asymetrically positioned relative to a central plane ABCD (as shown in FIG. 1) through the lure body 12. In the illustrated embodiment, the hook 30 is positioned in the central portion 48 of the lure body 12. In the illustrated embodiment, the hook 30 is a three pronged hook or a treble hook. In another embodiment, the hook 30 may include a single hook or a double hook. In one embodiment, loop 32 (as shown in FIGS. 2-4) may be connected to the hook 30 using ring 34. The loop 32 may be generally inserted into a groove (not shown) formed on the top side 18 of the left body portion 12 right body portion 12B of the lure body 12. In one embodiment, the size of the hook 30 is relatively larger than that of the size of the hook 26. For example, in one embodiment, the hook 30 is a # 4 treble hook and the hook 26 is a # 6 treble hook.

In one embodiment, the weight 14 is positioned on the hook 30 attached to the top side 18 of the lure body 12. In one embodiment, the weight 14 is asymmetrically positioned relative to the central plane ABCD (as shown in FIG. 1) through the lure body 12.

In one embodiment, eyes 84 are generally inserted into grooves (not shown) formed on outer surfaces of the left body portion 12A and the right body portion 12B of the lure body 12 of the fishing lure 10 and are adhered to the grooves using an adhesive. In one embodiment, as shown in FIG. 4, the maximum length of the fishing lure 10 generally is 4.375 inches, while the maximum height of the fishing lure is 0.6875 inches.

In one embodiment, as shown in FIG. 4, the lure body 12 comprises vent holes 100 and 102 to allow water to enter into the chamber 44 within the lure body 12 so as to stabilize the fishing lure 10. In one embodiment, the vent holes 100 and 102 located on the top side 18 and bottom side 20 of the fishing lure 12 respectively. In one embodiment, the left body portion 12A and the right body portion 12B encloses the vent holes 100 and 102 therebetween as the left body portion 12A and the right body portion 12B are adhered to one another.

The operation of the fishing lure 10 is described in detail with respect to FIGS. 1-4. The fishing lure 10, thus formed, is generally connected to an end of the fishing line (not shown), which is connected to a fishing rod and a reel (not shown). The fishing lure 10 is then cast into areas of water where target species of fish may be found. The fishing lure 10 may be skillfully moved in the areas of water to attract target species of fish, and to encourage the target species of fish to bite the fishing lure 10.

As the fishing lure 10 is pulled through water, the front lip 22 causes the fishing lure 10 to wiggle back and forth to simulate fish-like motion. This fish-like motion may catch the attention of the target species of fish.

When the fishing lure 10 comes to a standstill (i.e., when the fishing lure 10 is suspended in water without being pulled through water), the fishing lure 10 turns to the top side down orientation (as shown in FIG. 1) to simulate a dying fish (i.e., to make the fish appear like its dying or dead). As noted above, the weight 14 is positioned to bias the lure body 12 towards the top side down orientation, when the fishing lure 10 is suspended in water without being pulled through water. In other words, when the fishing lure 10 comes to a standstill, the weight 14 on the hook 30 that is positioned asymmetrically relative to the central plane ABCD through the lure body 10 makes the top portion of the lure body 12 of the fishing lure 10 heavy, thus, biasing the lure body 12 towards the top side down orientation.

As the fishing lure 10 is moved from the top side up orientation to the top side down orientation, the weight 40 in the lure body 12 rotates with the wire 52 such that the front lip 22 connected to the wire 52 retains its downwardly and forwardly orientation relative to the front end 24 of the lure body 12, when the fishing lure 10 is moved to the top side down orientation. Similarly, as the fishing lure 10 is moved from the top side up orientation to the top side down orientation, the rear hook 26 connected to the wire 52 rotates with the wire 52 so that the pointed end(s) 28 of the hook 26 always extends in the generally vertically upward direction, when the fishing lure 10 is moved to the top side down orientation.

As noted above, in one embodiment, the rotational movement of the wire 52 is limited to 180 degrees. This is achieved by the inner surface 98 (as shown in FIG. 4) of the second portion 92 of the chamber 44 that acts as a stop to engage with bent portion 88 of the wire 52, thus, limiting the rotational movement of the wire 52.

When the fishing lure 10 is pulled through water again in a forward motion, the fins 16 on the fishing lure 10 will cause the fishing lure 10 to rotate so that the fishing lure 10 assumes the top side up orientation. This is shown in FIGS. 2 and 3 where the fins 16 tend to propel the lure body 12 of the fishing lure 10 towards the top side up orientation, when the fishing lure 10 is pulled through water.

As the fishing lure 10 is moved from the top side down orientation to the top side up orientation, the weight 80 on the front lip 22 (and connected to the wire 52) retains the lip 22 in its downwardly and forwardly orientation relative to the front end 24 of the lure body 12, when the fishing lure 10 is moved to the top side up orientation. Similarly, as the fishing lure 10 is moved from the top side down orientation to the top side up orientation, the rear hook 26 connected to the wire 52 rotates with the wire 52 so that the pointed end(s) 28 of the hook 26 always extends in the vertically upward direction, when the fishing lure 10 is moved to the top side up orientation.

As noted above, the weight 80 causes the front lip 22 to retain its downwardly and forwardly orientation relative to the front end 24 of the lure body 12 irrespective of whether the lure body 12 is in the top side down or top side up orientation. Also, the same relative rotational movement of the body 12 relative to the weight 80 attached to the wire 52 causes the rear hook 26 to assume an orientation in which the pointed end(s) 28 of the hook 26 always extends in the vertically upward direction irrespective of whether the lure body 12 is in the top side down or top side up orientation. This orientation of the rear hook 26 in which the pointed end(s) 28 of the hook 26 always extends in the vertically upward direction helps in targeting the vulnerable inside lower mouth of the target species of fish irrespective of whether the lure body 12 is in the top side down or top side up orientation.

As noted above, and as shown in FIG. 4, the vent holes 100 and 102 located on the fishing lure 12 allow water to enter into the chamber 44 within the lure body 12 so as to stabilize the fishing lure 10.

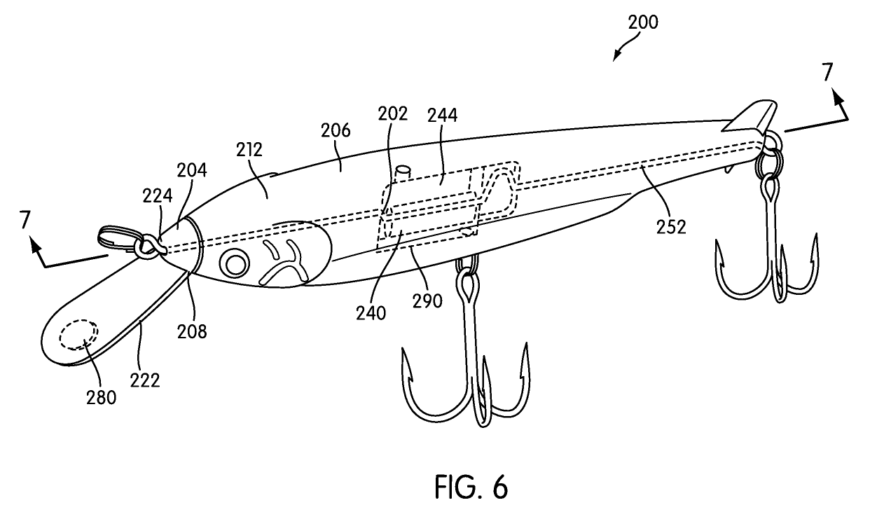

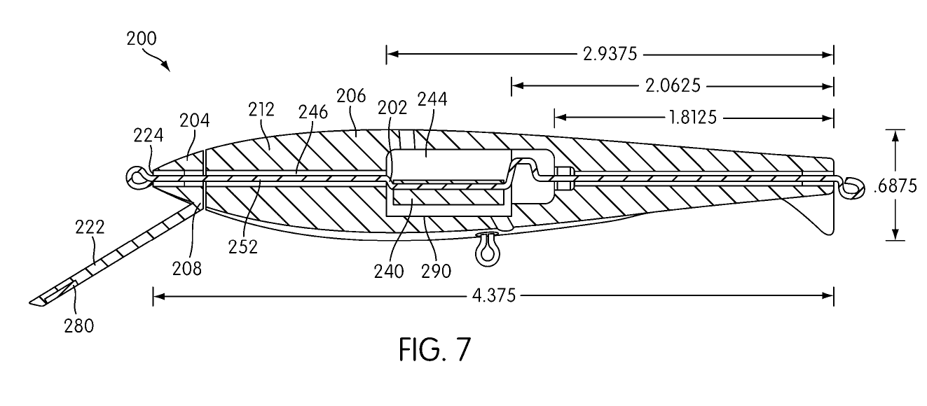

FIGS. 6 and 7 show another embodiment of the present invention in which a fishing lure 200 is shown. The operation of the fishing lure 200 is the same or similar to that of the fishing lure 10 described in the previous embodiment, and hence only some structural differences will be described in detail.

In one embodiment, a wire or rod 252 includes a bent portion 202 located in a first portion 290 of a chamber 244. The bent portion 202 is constructed and arranged to receive and position a weight 240 in slightly lowered configuration in comparison with the weight 40 (See FIG. 1) of the previous embodiment. In one embodiment, this lowered configuration of the weight 240 eliminates the need for the weight 14 attached to the hook 30 (See FIG. 1) as described in the previous embodiment. The lowered configuration of the weight 240 is configured not only to balance the fore/aft weight of the fishing lure 200 so that a lure body 212 is generally disposed towards a level orientation (balanced) when in water, but also to bias the lure body 212 towards the top side down orientation if the lure 200 is suspended in water without being pulled through water. The weight 240 also provides a counterbalance to a weight 280 carried by a lip 222 that retains the lip 222 in a downwardly and forwardly extending configuration.

In contrast to the previous embodiment, the fishing lure 200 includes a nose section 204 and a body section 206. The lip 222 is constructed and arranged to generally extend downwardly and forwardly relative to an end 208 of the nose section 204 of the fishing lure 200. In other words, the nose section 204 and the lip 222 form a single unitary piece having an opening or slot 246 therethrough that is constructed and arranged to receive the wire 252 therein. In the illustrated embodiment, as shown in FIGS. 6 and 7, the lip 222 is positioned at 0.25 inches from a front end 224 of the nose section 204 of the fishing lure 200. In one embodiment, the lip 222 along with the nose section 204 may be rotatable relative to the lure body 212. In such embodiment, the wire 252 can be fixed (e.g., glued or otherwise secured) to the slot within the nose section 204. The slot 246 may optionally be provided with rotatable bearing structures to facilitate the rotation of the wire 252 therein. The lip 222, which is attached to the nose section 204, causes the lure body 212 to wiggle if the lure 200 is pulled through water. Similar to the earlier embodiment, the lip 222 is weighted such that it retains a generally downwardly and forwardly extending orientation relative to the end 208 of the nose section 204 of the fishing lure 200 irrespective of whether the lure body 212 is in the top side up or top side down orientation.

It should thus be appreciated that the lure body can be weighted in a variety of different ways to bias the lure into the top-side down configuration. Indeed, in another embodiment, molded plastic or wood material forming the body shape of the fish itself can be top-heavy so as to bias the lure into the top-side down configuration. Any fins or other angled surfaces (at least one angled surface) on the lure body can be used propel the lure body towards a top side up orientation if the lure is pulled through water.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A fishing lure comprising:
a lure body shaped like a fish, the lure body having a top side and a bottom side;
the lure body being weighted such that it is biased towards a top side down orientation if the lure is suspended in water without being pulled through water; and
at least one angled surface on the body that tend to propel the lure body towards a top side up orientation if the lure is pulled through water.

2. A fishing lure of claim 1, wherein the lure body is weighted by a weight that is asymmetrically positioned relative to a central plane through the lure body.

3. A fishing lure of claim 2, wherein the weight is positioned on a hook attached to the top side of the lure body.

4. A fishing lure of claim 1, further comprising a front lip that causes the lure body to wiggle if the lure is pulled through water.

5. A fishing lure of claim 4, wherein the front lip is weighted such that it retains a downwardly and forwardly extending orientation relative to a front end of the lure body irrespective of whether the lure body is in the top side up or top side down orientation.

6. A fishing lure of claim 5, wherein the weighted configuration of the lip is provided by a weight within the lure body, the weight being connected to the lip by a rotatable rod.

7. A fishing lure of claim 1, further comprising a rear hook rotatably mounted to a rear end of the lure body, the rear hook being weighted such that it rotates relative to the lure body so that pointed end of the hook extends in a generally vertically upward direction irrespective of whether the lure body is in the top side up or the top side down orientation.

8. A fishing lure of claim 1, wherein the lure body comprises vent holes to allow water to enter into a chamber within the lure body so as to stabilize the lure.

9. A fishing lure of claim 1, wherein the at least one angled surface on the body is provided by one or more fins.

10. A fishing lure comprising:
a lure body shaped like a fish, the lure body having a top side and a bottom side; and
a front lip that extends downwardly and forwardly relative to a front end of the lure body, and causes the lure body to wiggle if the lure is pulled through water, the front lip being rotatable relative to the lure body, the lip being weighted such that it retains the downwardly and forwardly extending orientation relative to the front end of the lure body irrespective of whether the lure body is in a top side up or a top side down orientation.

11. A fishing lure of claim 10, wherein the weighted configuration of the lip comprises a weight within the lure body, the weight being connected to the lip by a rotatable rod.

12. A fishing lure of claim 11, wherein the weight is positioned within the lure body to balance the fore/aft weight of the lure.

13. A fishing lure of claim 10, further comprising a weight positioned to bias the lure body towards the top side down orientation if the lure is suspended in water without being pulled through water.

14. A fishing lure of claim 13, further comprising at least one angled surface on the body that tend to propel the lure body towards the top side up orientation if the lure is pulled through water.

15. A fishing lure of claim 10, further comprising a rear hook rotatably mounted to a rear end of the lure body, the rear hook being weighted such that it rotates relative to the lure body so that pointed end of the hook extends in a generally vertically upward direction irrespective of whether the lure body is in the top side up or top side down orientation.

16. A fishing lure of claim 10, wherein the lure body comprises vent holes to allow water to enter into a chamber in the lure body so as to stabilize the lure.

17. A fishing lure of claim 14, wherein the at least one angled surface on the body is provided by one or more fins.

18. A fishing lure comprising:
a lure body shaped like a fish, the lure body having a top side and a bottom side; and
a rear hook being weighted such that it rotates relative to the lure body so that pointed end of the hook always extends in a generally vertically upward direction irrespective of whether the lure body is in a top side up or a top side down orientation.

19. A fishing lure of claim 18, wherein the weighted configuration of the hook comprises a weight within the lure body, the weight being connected to the hook by a rotatable rod.

20. A fishing lure of claim 18, wherein the lure body comprises vent holes to allow water to enter into a chamber in the lure body so as to stabilize the lure.

21. A fishing lure of claim 18, further comprising a front lip that causes the lure body to wiggle if the lure is pulled through water.

22. A fishing lure of claim 21, wherein the front lip is rotatable relative to the lure body, and wherein the front lip is weighted such that it retains a downwardly and forwardly extending orientation relative to a front end of the lure body irrespective of whether the lure body is in the top side up or top side down orientation.

23. A fishing lure of claim 22, wherein the weighted configuration of the lip is provided by a weight within the lure body, the weight being connected to the lip by a rotatable rod.

24. A fishing lure of claim 18, further comprising a weight positioned to bias the lure body towards the top side down orientation if the lure is suspended in water without being pulled through water.

25. A fishing lure of claim 18, further comprising at least one angled surface on the body that tend to propel the lure body towards the top side up orientation if the lure is pulled through water.

26. A fishing lure of claim 25, wherein the at least one angled surface on the body is provided by one or more fins.
